(19) United States
(12) Patent Application Publication
(10) Pub. No.: US 2009/0103027 A1
(43) Pub. Date: Apr. 23, 2009

(54) Cholesteric Liquid Crystal Display Device

(76) Inventors: Christopher John Hughes, Reading (GB); David Coates, Wimbourne (GB); Anthony Orlando Alkins, Oxford (GB)

Correspondence Address: Pearl Cohen Zedek Latzer, LLP, 1500 Broadway, 12th Floor, New York, NY, 10036, US

(21) Appl. No.: 11/667,838

(22) PCT Filed: Nov. 14, 2005
(86) PCT No.: PCT/GB2005/004363

§ 371 Date: May 16, 2007

(30) Foreign Application Priority Data
Nov. 16, 2004 (GB) 0425276.3

(51) Int. Cl. G02F 1/1347

(52) U.S. Cl. 349/115

(57) ABSTRACT

A cholesteric liquid crystal display device (40) comprises a stack of three cells (10), each cell comprising a layer of cholesteric liquid crystal material (19) capable of being switched between a plurality of states including a planar state in which it reflects light with wavelengths in a central band (31) corresponding to red, green and blue, respectively, and in overtone bands (32, 33) on both sides of the central band (31). Each adjacent pair of cells 10 in the stack is held together by a layer of adhesive (42, 43). At least one of the layers of adhesive (42, 43) includes a red dye which is absorbent of light with wavelengths in the overtone bands (32) on the side of the central band (31) of lower wavelength. The red dye improves the perceived red colour of light reflected from the red cell (10R) by suppressing the overtone bands. The provision of the red dye in the adhesive provides several advantages in manufacture.

The present invention relates to a cholesteric liquid crystal display device. This is a type of display device for displaying an image and which has a low power consumption and a high brightness.

A cholesteric liquid crystal display device uses one or more layers of cholesteric liquid crystal material capable of being switched between a plurality of states. These states include a planar state in which the layer of cholesteric liquid crystal material reflects light with wavelengths in a band corresponding to a predetermined colour. In another state, the cholesteric liquid crystal transmits light. A fall colour display may be achieved by combining cholesteric liquid crystal material capable of reflecting red, blue and green light.

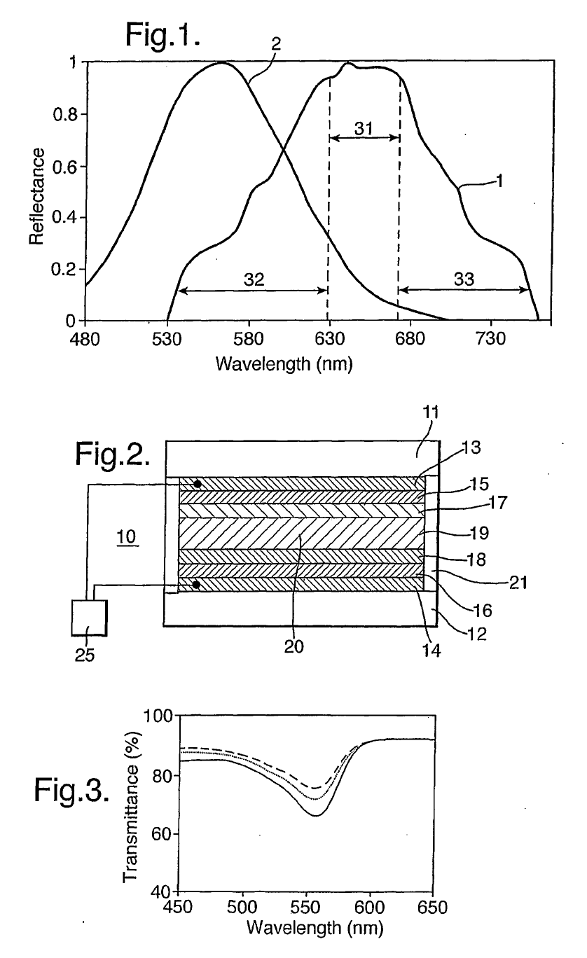

Cholesteric material capable of reflecting red light suffers from a known problem that it is perceived as being orange. This is caused by the physical properties of cholesteric liquid crystal material and the sensitivity of the eye, as follows. The reflection spectrum in the planar state as shown in FIG. 1 by the line 1 has a central band of wavelengths and overtone bands on both sides of the central band. The wavelengths reflected are dependent on the helical pitch P of the cholesteric liquid crystal material which is thus chosen so that the central band corresponds to a predetermined colour, in this case red. However, the sensitivity of the eye as shown in FIG. 1 by the line 2 has a peak on the side of the central band of lower wavelength. This accentuates the overtone bands around the peak of lower wavelength and results in the viewer perceiving the colour as shifted towards shorter wavelengths so that they are seen as orange rather than red.

Some known ways to tackle this problem are as follows.

One approach which has been considered is to use a cholesteric material having a relatively low birefringence so that weaker overtone bands are generated. However this way of suppressing the overtone bands reduces the brightness of the reflected red light.

Hashimoto et al., “Reflective Color Display Using Cholesteric Liquid Crystals”, Society for Information Displays 1998, Paper 31.1 discloses the technique of adding a red dye to the layer of cholesteric liquid crystal material. The red dye absorbs light with wavelengths in the overtone bands on the side of the central band of lower wavelength. Such suppression of the overtone bands reduces the perception of orange when the reflected light is viewed.

However, the use of a red dye in the cholesteric liquid crystal material suffers from a number of drawbacks. One drawback is that the dye degrades and causes impurity in the liquid crystal material which leads to ionic contamination and higher current, lowering of clearing point of the liquid crystal. This is a particular problem where the display is used outdoor as sunlight causes rapid degradation. Additionally, dyes are high viscosity additives that lead to long response times of the liquid crystal material. Red dyes for this use must be very pure otherwise they add unwanted contaminants. Such dyes are of limited availability and are very expensive, as the purification has to be very extensive and thus costly. Despite these problems, red dyes in the liquid crystal material are often used for indoor applications.

U.S. Pat. No. 6,005,654 discloses a technique of using a red filter to reduce the perception of orange when the reflected light is viewed in a similar manner to the use of a red dye in the liquid crystal material. The red filter is either deposited on the substrate used to contain the cholesteric liquid crystal or else is incorporated into the substrate itself. A similar method using a red filter is disclosed in Dvir, Shalom and Coates, “P-106: Physchophysical Perception Enhancement of Red Cholesteric Liquid Crystal to Improve the Total Performance of a Full Colour Outdoor Cholesteric Display”, Society for Information Displays Digest, 2003, pp 628-631.

However the use of a red filter applied in this way introduces difficulties during manufacture. The formation of a substrate with the filter incorporated therein is not convenient in practice. The application of a red filter is problematic because it must be applied as a thin film which is very accurately printed to a uniform thickness to give a specific optical density so that the red colour is repeatable. Whilst this is possible in theory, in practice to give a coating of sufficiently good quality is a is a low yield process. Furthermore the filter must be smooth and be able to withstand the solvent effects of the glues prior to curing and must have good bonding properties to the substrate. Very few types of ink possess these properties especially when used in a clean room environment. The solvents used in this printing process have environmental and health hazard implications. No water based non-toxic inks for bonding to glass exist at present. The commercially available pigments which meet all these requirements have limited spectral ranges so the ideal filter cannot be provided.

It would be desirable to provide a cholesteric display which reduces the perception of orange in the light reflected from the layer of cholesteric liquid crystal material which reflects red light, whilst reducing the problems with the known techniques for doing this as discussed above.

According to the present invention, there is provided a cholesteric liquid crystal display device comprising:

a stack of cells, each cell comprising a layer of cholesteric liquid crystal material capable of being switched between a plurality of states including a planar state in which it reflects light with wavelengths in a central band corresponding to a predetermined colour and in overtone bands on both sides of the central band, the cells including a red cell having a predetermined colour of red, and the red cell being at a position in the stack other than the front; and

a layer of adhesive each holding together each pair of adjacent cells in the stack, at least one layer of adhesive in front of the red cell including a colourant which is absorbent of light with wavelengths in the overtone bands on the lower wavelength side of the central band of the red cell but is less absorbent of light with wavelengths in the central band of the red cell.

Thus the present invention uses a display device using plural cells in a stack, for example a red cell, a blue cell and a green cell for a full colour display. The stack is held together by layers of adhesive. This configuration has the advantage that the individual cells may be separately manufactured and subsequently attached together. The use of adhesive to hold the layers together prevents slippage of the layers and prevents the formation of a thin air gap which would degrade the optical properties.

In addition, the present invention takes advantage of the adhesive by including in at least one layer in front of the red cell a red colourant. This red colourant is absorbent of light with wavelengths in the overtone bands on the side of the central band of lower wavelength. Such suppression of the overtone bands reduces the perception of orange when the reflected light is viewed, in a similar manner to known techniques of using a red dye in the cholesteric liquid crystal material or of using a red filter, as discussed above. However, the provision of the red colourant in the adhesive provides a number of advantages in the manufacture of the display device.

The inclusion of the red colourant into the adhesive is very easy to perform. For example, a suitable quantity of the red colourant might simply be mixed into the adhesive as a preliminary step to affixing the cells together. In particular, this is simpler than the incorporation of a red dye in the cholesteric liquid crystal material or the application of a red filter, as discussed above. Thus the present invention eliminates a low yield step.

As the red colourant is provided in the adhesive rather than in the liquid crystal material, the purity of the red colourant is less critical. As a result, the colourant used can be selected from a wide range of inexpensive, commercially available products. Advantageously, the red colourant is a red dye. This makes it easy to incorporate into the adhesive, for example simply by mixing. As an alternative, the red colourant could be a red pigment although this would require special mixing into the adhesive to prevent agglomeration and settling.

As the red colourant is in the adhesive which forms a solid matrix after curing, it is more stable than if included within the liquid crystal material which is of course a liquid.

A further advantage is that any degradation of the red colourant over the lifetime of the display device will not affect the liquid crystal material. Thus, although the degradation might limit the effectiveness in suppressing the overtone bands it will not affect the fundamental operation of displaying an image.

One might expect that the red colourant will inhibit curing of the adhesive. However, it has been found in the examples discussed further below, that this does not in fact occur.

Typically, the adhesive is an ultra-violet curable adhesive. In this case, one might expect that the adhesive will generate free radicals when exposed to the ultra-violet light used for curing. However, it has been found in the examples discussed further below, that this does not seriously affect the colour or absorption of the red colourant.

A display device which is an embodiment of the present invention will now be described by way of non-limitative example with reference to the accompanying drawings, in which:

FIG. 1 is a graph of the reflection spectrum of a cholesteric liquid crystal material in the planar state, also showing the sensitivity of the eye;

FIG. 2 is a cross-sectional view of a single cell of a display device;

FIG. 3 is a graph of the transmittance spectrum of some red dyes;

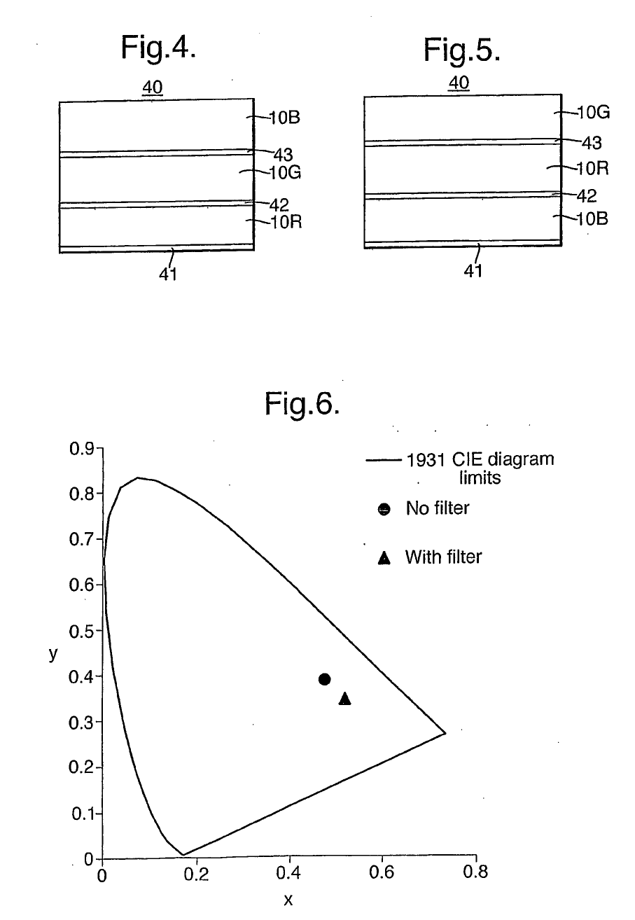

FIG. 4 is a cross-sectional view of a display device; and

FIG. 5 is a cross-sectional view of a further display device; and

FIG. 6 is a chromacity diagram showing the performance of a red dye.

There will first be described a single cell 10 which may be used in a cholesteric liquid crystal display device. The cell 10 is shown in FIG. 2 and has a layered construction, the thickness of the individual layers being exaggerated in FIG. 2 exaggerated for clarity.

The cell 10 comprises two rigid substrates 11 and 12, which may be made of glass or preferably plastic. The substrates 11 and 12 have, on their inner facing surfaces, respective transparent electrode layers 13 and 14 formed as a layer of conductive material, typically indium tin oxide. The electrode layers 13 and 14 are patterned in a conventional manner to provide a rectangular array of independently addressable pixels in a liquid crystal layer 19 (described further below), for example with a passive drive arrangement in which the electrode layers 13 and 14 are each arranged as an array of linear electrodes extending perpendicular to each other to form a pixel at the overlap between an electrode of each electrode layer 13 and 14.

Optionally, the electrode layers 13 and 14 are overcoated with a respective insulation layer 15 and 16, for example of silicon dioxide.

The substrates 11 and 12 define between them a cavity 20, typically having a thickness of 3 to 8 μm. The cavity 20 contains a liquid crystal layer 19 and is sealed by a glue seal 21 provided around the perimeter of the cavity 20. Thus the liquid crystal layer 19 is arranged between the electrode layers 13 and 14.

Each substrate 11 and 12 is further provided with a respective alignment layer 17 and 18 formed on the inside of the cell, that is covering the respective electrode layer 13 and 14, or the insulation layer 15 and 16 if provided. The alignment layers 17 and 18 align and stabilise the liquid crystal layer 19 and are typically made of polyimide which may optionally be unidirectionally rubbed. Thus, the liquid crystal layer 19 is surface-stabilised, although it could alternatively be bulk-stabilised.

The operation of the cell 10 is as follows.

The liquid crystal layer 19 comprises cholesteric liquid crystal material. Such material has two stable states which can coexist when no voltage is applied to the liquid crystal layer 19. These stable states are the planar and focal conic states, as described in I. Sage, Liquid Crystals Applications and Uses, Editor B Bahadur, vol 3, page 301, 1992, World Scientific, which is incorporated herein by reference and the teachings of which may be applied to the present invention.

In the planar state, the liquid crystal layer 19 selectively reflects a bandwidth of light that is incident upon it. The wavelengths λ of the reflected light are given by Bragg's law, ie λ=nP, where wavelength λ of the reflected wavelength, n is the refractive index of the liquid crystal material seen by the light and P is the pitch length of the liquid crystal material. Thus in principle any colour can be reflected as a design choice by selection of the pitch length P. That being said, there are a number of further factors which determine the exact colour, as known to the skilled person. The rest of the light not reflected by the liquid crystal layer 19 is transmitted through the liquid crystal layer 19.

The reflectance spectrum 1 of the liquid crystal layer 19 is shown in FIG. 1 for the example of reflection of red light. The reflectance spectrum 1 has a central band 31 of wavelengths in which the reflectance of light is substantially constant. This is due to the birefringence of the cholesteric liquid crystal material and corresponds to reflection of light at different angles relative to the ordinary and extraordinary axes, the light at each angle seeing a different refractive index which causes a different wavelength λ to be reflected. On the lower and upper wavelength sides of the central band 31, the reflectance spectrum 1 has respective overtone bands 32 and 33 in which the reflectance is lower than in the central band 31.

In the focal conic state, the liquid crystal layer 19 is transmissive and transmits incident light. Strictly speaking, the liquid crystal layer 19 is mildly light scattering with a small reflectance, typically of the order of 3-4%, and so is transmissive relative to the reflectance in the planar state. As light transmitted through the liquid crystal layer is absorbed by the black layer 41 described in more detail below, this state is perceived as darker than the planar state. Thus the focal conic state is used as the black state.

Furthermore the liquid crystal layer 19 can exist in stable states in which different domains of the liquid crystal material are each in a respective one of the focal conic state and the planar state. These are sometimes referred to as mixture states. In these mixture states, the liquid crystal material has a reflectance intermediate the reflectances of the focal conic and planar states. A range of such stable states is possible with different mixtures of the amount of liquid crystal in each of the focal conic and planar states so that the overall reflectance of the liquid crystal material varies.

A control circuit 25 supplies drive signals to the electrode layers 13 and 14 to apply an electric field across the liquid crystal layer 19 to drive the liquid crystal material into one of the stable states and thereby to change the reflectance of the liquid crystal layer 19 for displaying an image to a viewer. This effect is described in W. Gruebel, U. Wolff and H. Kreuger, Molecular Crystals Liquid Crystals, 24, 103, 1973 which is incorporated herein by reference and the teachings of which may be applied to the present invention. The drive signals are applied to selectively drive regions of the liquid crystal layer 19 as respective pixels. For example in the case that the electrode layers 13 and 14 are patterned to provide a passive drive electrode as described above, the drive signals are applied across selective combinations of the electrodes in each electrode layer 13 and 14 to drive the pixels at the overlap between the electrodes.

Grey scale may be achieved by suitable drive signals which drive the liquid crystal material into the stable mixture states having reflectances intermediate the reflectances of the focal conic and planar states, for example as disclosed in Huang et al., “Full Color (4096 Colors) Reflective Cholesteric Liquid Crystal Display”, Asia Display 1998, pp 883-885 1973, which is incorporated herein by reference and the teachings of which may be applied to the present invention.

The drive signals are only supplied when the liquid crystal layer 19 is required to change from the planar state to the focal conic state and vise versa. Thus the power consumption is low.

Typically the drive signals take the form of pulses. The pulses may be of 30-50V with an AC pulse of duration 50-100 ms to switch the liquid crystal into the planar state. The pulses may be one or more (often 2 to 5) pulses of 10-20V and 50 ms duration to switch the liquid crystal into the focal conic state. The optimisation of the drive pulses may be found experimentally for a given configuration of the cell 10 as the exact amplitude and duration depends on a number of factors such as the thickness of the liquid crystal layer 19, the dielectric anisotropy of the liquid crystal and temperature. Thus the actual drive signal may differ from the values given above although those values are suitable starting values for the optimisation process.

Cholesteric liquid crystal material also has a homeotropic state in which it is even more transmissive than in the focal conic state, typically having a reflectance of the order of 0.75%. Optionally the liquid crystal layer 19 may be switched in use into the homeotropic state to act as the black state. This has the advantage of increasing the contrast ratio. On the other hand, the homeotropic state is not stable and so requires the drive signal to be maintained. Thus, use of the homeotropic state consumes additional power, but in practice the overall power consumption is relatively low as typical images require only a fraction of the cell 10 to be in the black state.

A display device 40 will now be described with reference to FIG. 4.

The display device 40 comprises a stack of cells 10R, 10G and 10B, each being a cell 10 of the type shown in FIG. 2 and described above. The cells 10R, 10G and 10B have respective liquid crystal layers 19 which are arranged to reflect light with the wavelengths of the central band 31 corresponding to red, green and blue, respectively. Thus the cells 10R, 10G and 10B will thus be referred to as the red cell 10R, the green cell 10G and the blue cell 10B. In FIG. 4, the front of the display device 40 from which side the viewer is positioned is uppermost and the rear of the display device 40 is lowermost.

The display device 40 has a black layer 41 disposed to the rear, in particular by being formed on a rear surface of the red cell 10R which is rearmost. The black layer 41 may be formed as a layer of black paint. In use, the black layer 41 absorbs any incident light which is not reflected by the cells 10R, 10G or 10B. Thus when all the cells 10R, 10G or 10B are switched into the black state, the display device appears black.

The adjacent pair of cells 10R and 10G and the adjacent pair of cells 10G and 10B are each held together by respective adhesive layers 42 and 43.

The adhesive of either one or both of the adhesive layers 42 and 43 includes a red colorant. The red colourant may be a red pigment in the form of solid particles but for ease of mixing with the adhesive layers 42 and 43 the red colourant is preferably a red dye mixed or dissolved in the adhesive.

The red colourant is absorbent of light with wavelengths in the overtone bands 32 on the side of lower wavelengths of the central band 31 of the red cell 10R. As a result, the red colourant suppresses the reflection of light in those overtone bands 32 when the liquid crystal layer 19 of the red cell 10R is in the planar state. This reduces the perception of orange in the red light which is reflected from the display device 40.

To maintain the desired reflection of red light, the red colourant is less absorbent of light with wavelengths in the central band 31 of the red cell 10R than in the lower wavelength overtone bands 32. Preferably, the red colourant is not absorbent of light with wavelengths in the central band 31 of the red cell 10R at all. By way of example, FIG. 3 represents the transmittance spectrum of a suitable red colourant. The ideal dye depends on the reflection spectrum of the actual liquid crystal layer 19 of the red cell 10R.

Many commercially available red colourants may be used. Examples of suitable red dyes are Sudan Red B, Solvent Red 19 (Sudan red 7B), Solvent Red 23 (Sudan M), Solvent Red 24 (Sudan IV), Solvent Red 26 (Oil Red EGN), Solvent Red 27 (Oil Red O), Solvent Red 45 (Ethyl eosin), Solvent Red 49, Solvent Red 111, Solvent Red 135. In this list of red dyes, the primary names given are those names under the widely used system of Colour Index Generic Name and sometimes referred to by the initials CI (e.g. CI Solvent Red 135). The secondary names given in brackets are alternative names for the same dyes.

The adhesive of the adhesive layers 42 and 43 is a transparent adhesive of the type used to affix panels of glass together and may also be used to affix cells of cholesteric liquid crystal display devices. The adhesive may be any of a large number of commercially available products. Most commonly the adhesive is ultra-violet curable. Suitable ultra-violet curable adhesives are available from Loctite (eg Loctite 3499), Norland (eg NOA 72), Slink (eg Slink 2395, RX10131, 833). Alternatively, the adhesive may be heat-curable.

In the display device 40 shown in FIG. 4, the order of the cells 10 from rear to front is the red cell 10R, the green cell 10G and the blue cell 10B. This is preferred for the reasons disclosed in West and Bodnar, “Optimization of Stacks of Reflective Cholesteric Films for Full Color Displays”, Asia Display 1999 pp 20-32. In the case that the red cell 10R is the rear cell, it is preferred that the red colourant is provided in the rear adhesive layer 42, but not in the front adhesive layer 43. This has the advantage that the red adhesive does not affect the light which is reflected from the blue cell 10B and the green cell 10G when in the planar state.

In fact, any other order is possible (although not ideal) provided that at least one adhesive layer 42 or 43 including the red colourant is in front of the red cell 10R. This means that the red cell 10R cannot be the front cell. The red cell 10R can be the middle cell, for example as in the alternative form of the display device 40 shown in FIG. 4 but in this case, the front adhesive layer 43 must include the red colourant.

In general, the present invention is applicable to a display device having any plural number of cells including a red cell in any position other than the front.

The display device 40 may be manufactured as follows.

The individual cells 10R, 10G and 10B are of a conventional construction and may be manufactured using conventional techniques.

Before fixing the individual cells 10R, 10G and 10B together, the red colourant is mixed into the adhesive to give the homogeneous distribution of the red colourant. If the red colourant is a red dye, this is a simple matter of mixing. On the other hand, if the red colourant is a red pigment which remains in solid form, then it might be needed to take special measures to prevent agglomeration and settling of the red pigment in the adhesive, such measures being conventional in themselves in respect of the pigment concerned.

The concentration of the red colourant in the adhesive is selected to provide an optical density typically in the range 0.05 to 0.4, but preferably in the range 0.1 to 0.2.

Optionally, spacer elements may also be mixed in with the adhesive. The spacer elements ensure that the adhesive layers 42 and 43 in the display device 40 are of a controlled and uniform thickness. Typically, the spacer elements may be of diameter of the order of 50 μm and may form 0.1-1% by weight of the adhesive layers 42 and 43.

The cells 10R, 10G and 10B are adhered together as follows. A drop of the red adhesive (of size dependent on the size of the display device 40) is placed on the red cell 10R and spread out to form the rear adhesive layer 42, eliminating any air bubbles. The green cell 10G is then gently lowered onto the rear adhesive layer 42 and pressed down. The process is then repeated but with adhesive absent of red colourant to form the front adhesive layer 43 and to position the blue cell 10B.

Subsequently, the adhesive of the adhesive layers 42 and 43 is cured by exposing the display device 42 to ultra-violet light, typically from a black light ultra-violet lamp. The radiation time is typically a few minutes.

To establish the correct concentration of the red colourant to give the desired optical density, it is possible to stack cells 10 which are empty of liquid crystal using adhesive layers 42 and 43 with differing concentrations of red colourant and to measure the optical density and to measure the resulting optical density using an optical densitometer, for example an X-Rite 361T optical densitometer.

To illustrate the optical performance of the display device 40, measurements have been taken for the example of the red colourant being Solvent Red 19 (Sudan Red 7B) and the adhesive of the adhesive layers 42 and 43 being Slink 2395. The results are shown in FIG. 5 which is a CIE chromaticity diagram and in Table 1 which lists the colour components x y of the red light reflected from the red cell 10R, as well as listing the brightness Y of the display device 40. The performance is illustrated both with and without the presence of the red colourant, in the case that the liquid crystal layer 19 has a birefringence of 0.2 and the red cell has a maximum reflection wavelength of 648 nm.

TABLE 1

| Red cell with no colourant | | | Red cell with colourant | | |
|---|---|---|---|---|---|
| Y | x | y | Y | x | y |
| 204.4 | 0.4758 | 0.3858 | 136.4 | 0.5198 | 0.3429 |
| cd/m² | | | cd/m² | | |

Table 1 and FIG. 5 show that the use of the red colourant improves the red colour deceived by a viewer.

1. A cholesteric liquid crystal display device comprising:
a stack of cells, each cell comprising a pair of substrates defining between them a cavity containing a layer of cholesteric liquid crystal material capable of being switched between a plurality of states including a planar state in which it reflects light with wavelengths in a central band corresponding to a predetermined colour and in overtone bands on both sides of the central band, the cells including a red cell having a predetermined colour of red, the red cell being at a position in the stack other than the front; and
a layer of adhesive holding together each pair of adjacent cells in the stack, at least one layer of adhesive in front of the red cell including a colourant which is absorbent of light with wavelengths in the overtone bands on the lower wavelength side of the central band of the red cell but is less absorbent of light with wavelengths in the central band of the red cell.

2. A cholesteric liquid crystal display device according to claim 1, comprising a stack of three cells wherein the red cell is the rear cell and the colourant is included in the rear layer of adhesive, but not the front layer of adhesive.

3. A cholesteric liquid crystal display device according to claim 1, wherein the colourant is a dye.

4. A cholesteric liquid crystal display device according to claim 3, wherein said dye is one selected from the group consisting of: Sudan Red B, Solvent Red 19, Solvent Red 23, Solvent Red 24, Solvent Red 26, Solvent Red 27, Solvent Red 45, Solvent Red 49, Solvent Red 111, Solvent Red 135 or any combination thereof.

5. A cholesteric liquid crystal display device according to claim 1, wherein the adhesive of said layers of adhesive is an ultraviolet curable adhesive.

6. A cholesteric liquid crystal display device according to claim 5, wherein the adhesive of said layers of adhesive is one selected from the group consisting of: Loctite 3499, Norland Optical Adhesive 72, Slink 2395, RX10131 or Slink 833.

7. A cholesteric liquid crystal display device according to claim 1, wherein the adhesive of said layers of adhesive is a heat curable adhesive.

8. A cholesteric liquid crystal display device according to claim 1, wherein the optical density of the at least one of the layers of adhesive including a colourant is in the range from 0.05 to 0.4.

9. A cholesteric liquid crystal display device according to claim 8, wherein the optical density of the at least one of the layers of adhesive including a colourant is in the range from 0.1 to 0.2.

10. A cholesteric liquid crystal display device according to claim 1, wherein the colourant is not absorbent of light with wavelengths in the central band.

11. (canceled)

12. A cholesteric liquid crystal display device according to claim 1, wherein the layer of cholesteric liquid crystal of each cell is arranged between electrode layers for receiving drive signals, the layer of cholesteric liquid crystal being switchable by drive signals applied to the electrode layers.

13. A cholesteric liquid crystal display device according to claim 12, wherein the electrode layers of each cell are formed on the substrates.

14. A cholesteric liquid crystal display device according to claim 1, further comprising a black layer disposed to the rear of the stack of cells.

15. A cholesteric liquid crystal display device according to claim 1, wherein the substrates are made of glass.
